(19) United States
(12) Patent Application Publication
(10) Pub. No.: US 2011/0169960 A1
(43) Pub. Date: Jul. 14, 2011

(54) VIDEO ENHANCEMENT SYSTEM

(75) Inventor: Matthias Wagner, Cambridge, MA (US)

(73) Assignee: REDSHIFT SYSTEMS CORPORATION, Burlington, MA (US)

(21) Appl. No.: 11/938,491

(22) Filed: Nov. 12, 2007

Related U.S. Application Data
(60) Provisional application No. 60/858,654, filed on Nov. 13, 2006.

(51) Int. Cl. H04N 5/30

(52) U.S. Cl. 348/162; 348/E05.09

(57) ABSTRACT

A video system includes first and second sensors generating respective primary and secondary video sequences of images of a scene. The first sensor is responsive to thermal infrared (IR) energy, and the second sensor is responsive to shorter-wavelength optical energy in a range from visible to near-IR wavelengths. The sensors are temporally and spatially registered. A motion estimation module generates an estimated motion vector field from the secondary video sequence, and a motion-based image processor applies one or more image-enhancement operations to the primary video sequence based on the estimated motion vector field. The video system may include an additional sensor motion estimation module operating on the primary video stream as well as a merging module that combines the estimated motion vector fields from the sensor motion estimation modules to produce a joint motion vector field having generally more precise motion estimation, further improving the quality of the enhanced video stream from the image processor.

### CROSS REFERENCE TO RELATED APPLICATIONS

This Patent Application claims the benefit under 35 U.S.C. §119(e) of U.S. patent application Ser. No. 60/858,654 filed on Nov. 13, 2006 and entitled, Video Enhancement System, the contents and teachings of which are hereby incorporated by reference in their entirety.

### BACKGROUND

Methods are known for enhancing a video stream or sequence of images to provide higher signal-to-noise ratio (whether it be temporal noise or fixed pattern noise) or higher effective pixel resolution, based on information contained in the video sequence itself. Such systems have been demonstrated in multiple applications and over multiple imaging modalities, including the visible and infrared regimes.

Many of these systems are based on motion estimation or “optical flow” techniques. Motion vectors are calculated in the image, and this information is used to track objects over multiple frames. Redundancy from frame to frame may then be used to enhance the image in a variety of ways, including temporal noise reduction through temporal filtering of pixel values that is motion-compensated, spatial or fixed pattern noise reduction (offset and gain coefficient extraction) through the use of differing pixel responses to the constant object moving across them, and pixel super-resolution through the use of sub-pixel motion estimates and object edges which traverse multiple pixels. The techniques for motion estimation have been highly refined, for visible images in particular, for use in video compression (which likewise uses features which are redundant from frame to frame), and are in many cases implemented in low-cost chips used in digital cameras, mobile phones, and security cameras. Specialized, simpler techniques involving similar algorithms are employed to image stabilization.

Methods for combining image sequences from different imaging modalities have also been demonstrated. Of particular interest has been the combination of visible images with other modalities including short-, mid- and long-wave infrared (SWIR, MWIR, LWIR respectively) where information regarding temperature and object surface properties may be derived from an image. In addition, work has been done to combine terahertz or millimeter-wave imagery with visible images. Primarily these “image fusion” efforts have focused on presenting a composite image to the user with a variety of techniques for determining the output image values from one or more input image streams. Relatively little has been done to guide the processing of one image stream with information from another, except to determine regions of interest on which to focus or overlay content.

### SUMMARY

In accordance with embodiments of the invention, a technique is disclosed in which a primary video stream such as from an infrared (IR) imaging sensor is enhanced using motion estimation derived from a secondary video stream, for example a visible-light sensor receiving optical energy from the same scene. The secondary video stream may be of higher resolution and/or higher signal-to-noise ratio, for example, and may thus provide for motion estimation of greater accuracy than may be obtainable from the primary video stream itself. As a result, the primary video stream can be enhanced in any of a number of ways to achieve desired system benefits, including for example image stabilization, pixel super-resolution, and other image enhancement operations.

More specifically, a video system includes a first sensor that generates, in response to thermal infrared (IR) optical energy from a scene, a primary video sequence of thermal IR images of the scene, and a second sensor that generates a secondary video sequence of images of the scene in response to shorter-wavelength optical energy from the scene. The shorter-wavelength optical energy is in a shorter-wavelength range from visible to near-IR wavelengths. The first and second sensors are temporally and spatially registered with respect to each other such that a portion of the scene has a known location in each of the primary and secondary video sequences.

A sensor motion estimation module generates an estimated motion vector field for the scene in response to the secondary video sequence, and a motion-based image processor generates an enhanced primary video sequence by applying one or more image-enhancement operations to the primary video sequence based on the estimated motion vector field. Examples of such image-enhancement operations are described below.

In specific embodiments, the video system also includes an additional sensor motion estimation module operating on the primary video stream as well as a merging module that combines the estimated motion vector fields from the sensor motion estimation modules to produce a joint motion vector field having generally more precise motion estimation that that from the primary video stream, and the motion-based image processor applies the image-enhancement operations to the primary video sequence based on the joint motion vector field.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a block diagram of a video enhancement system according to an embodiment of the invention; and

FIG. 2 is a block diagram of a video enhancement system according to a second embodiment of the invention.

### DETAILED DESCRIPTION

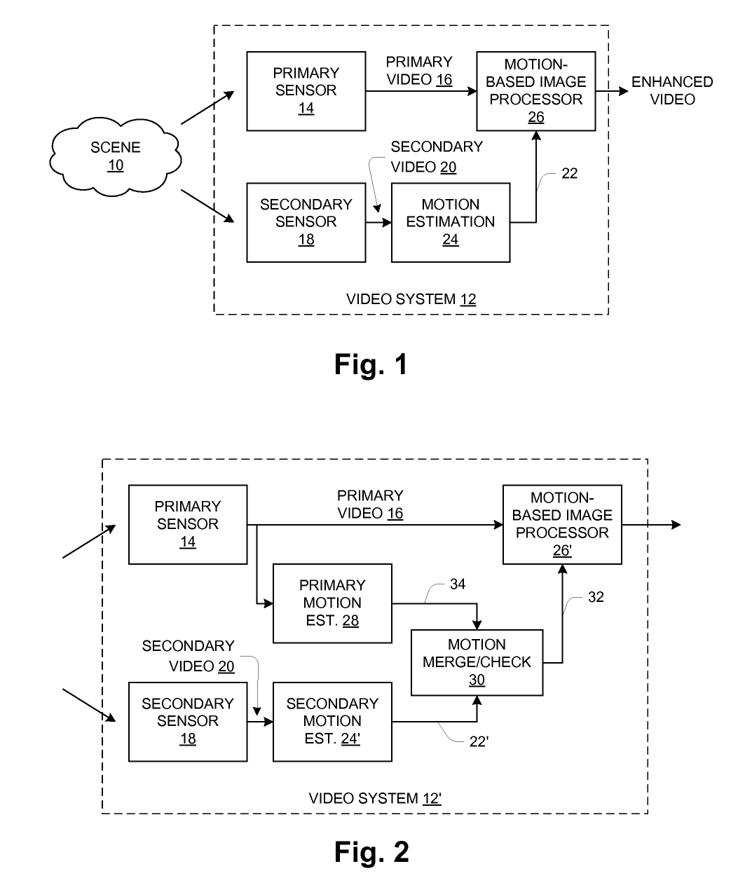

FIG. 1 is a schematic diagram of a video system employing video enhancement. A scene 10 generates optical energy in two different sections or bands of the electromagnetic spectrum, including in the thermal infrared (IR) band as well as in a shorter-wavelength band such as the visible or near-IR range. A video system 12 is used to generate thermal-IR-based video of the type generally useful in thermal imaging applications. The video system 12 may be a thermal camera, for example, as generally used for various thermal inspection activities. The video system 12 employs video enhancement to improve the image quality of the thermal-IR-based video generated by the video system 12.

A first or primary sensor 14 produces a primary video stream or sequence (primary video) 16 using the modality or wavelength band which is of primary interest to the end-user of the system, such as the thermal-IR band. A secondary sensor 18 produces a secondary video stream 20 of a different modality or wavelength band, generally of shorter wavelengths than the primary wavelength band to which the primary sensor 14 responds. The secondary video stream 20 is used primarily to generate a high-resolution estimated motion vector field 22 that approximates the motion in the scene for both modalities. The secondary video stream 20 is typically higher in resolution than the primary video stream 16 which contains the primary signal of interest. The secondary video stream 20 may have higher pixel (spatial) resolution, higher frame rate (time resolution), higher intensity resolution, and/or higher signal-to-noise ratio than the primary video stream 16.

A motion estimation module 24 receives the secondary video stream 20 and generates, on the basis of multiple image frames, the estimated motion vector field 22 for the scene. The methods for obtaining such a field are well known and have been applied to a variety of systems including primarily video compression systems. Most of the common motion estimation methods produce not only estimated motion vectors, but also a corresponding array of confidence values which reflect the “degree of match” of a block of pixels from one frame to the next along a calculated vector. Thus in some embodiments the estimated motion vector field 22 may include both estimated motion vectors as well as corresponding confidence values. The estimated motion vector field 22 may be in a variety of formats, such as per-pixel motion information, or in the form of a hierarchical set of motion vectors from a multi-scale motion estimation algorithm.

The estimated motion vector field 22 is passed to a motion-based image processor 26 which performs the ultimate image processing of the primary video stream 16. The motion-based image processor 26 may use the estimated motion vector field 22 to perform a number of enhancements on the primary video stream 16, including but not limited to the following:

1. Temporal Filtering for Signal-to-Noise Enhancement

A relatively simple way to achieve higher signal-to-noise ratios in video streams dominated by temporal noise (such as shot noise or dark current noise) is to implement temporal filtering. Averaging pixel values over multiple frames, however, produces image “smear” in the presence of moving objects, or if the entire camera is moving, rotating or zooming. Motion-compensated temporal filtering performs this multi-frame averaging or filtering along motion trajectories, and thereby minimizes resulting smear while providing significant signal-to-noise ratio enhancements. Such motion-driven filtering is not limited to temporal—in the case where there is very rapid motion (and the system is displaying images to a human) it may be feasible to apply spatial filtering as well, taking advantage of the fact that human vision has limited spatial bandwidth on objects in motion.

2. Spatial Super-Resolution

Building images with higher effective pixel resolution from a lower-resolution video stream has been demonstrated by a number of groups. Such techniques are applied to visible image streams for security-related “video forensics,” for instance. In these applications it is necessary to run an intensive, iterative process to estimate motion at a sub-pixel level and then do motion-compensated processing to arrive at a super-resolved image. In the present invention, we already have computed a motion vector field which may be at a higher resolution than the primary imaging sensor 14. Therefore it may be possible to generate a super-resolved image directly, rather than with an iterative process, making real-time super-resolution more attainable. Such a technique is particularly useful when the primary image sensor 14 operates in a modality that requires inherently expensive or low-yield imaging technology or associated optics (such as terahertz, millimeter-wave or thermal imaging), and it is therefore highly desirable to achieve a high-resolution image with the use of a lower-resolution primary sensor.

3. Scene-Based Non-Uniformity Correction

Many imaging technologies, particularly those outside the visible wavelength range, suffer from variations over their pixel arrays in bias (offset) and gain, many of which may be highly nonlinear and vary with age, temperature, and other effects. Such variations manifest themselves in an output image as fixed-pattern noise (FPN). Several methods are used to address FPN in these devices: first, most are factory-calibrated, often over multiple ambient temperature ranges, and over multiple scenes. This process may be expensive and time-consuming. Furthermore, an assumption that pixel parameters stay constant over the lifetime of the imaging system is often false, and leads to product returns and the need for recalibration. A second method employed by such systems is a limited in-operation recalibration, often through the use of one or more image shutters which occlude the scene and present a known target to the image sensor array.

The use of such “flag-based” calibration systems has a number of serious drawbacks: (a) they introduce a mechanical element into the system which often becomes the major source of product failures; (b) they cause a break in the video sequence which may produce a visible “freeze” in a video output to a human observer; when they are presented to a machine vision system which is interpreting a real-time video it may cause a major disruption and make the system unusable for mission-critical image processing; (c) for some military applications the audible actuation of this flag calibration system becomes a liability to the mission, and is therefore often disabled during critical moments, trading image quality for silence; and (d) such elements represent another source of power draw and cost in these imaging systems.

For these reasons it would be highly desirable to design a system that extracts pixel parameters such as bias and gain in real time. Several algorithms for extracting these parameters have been proposed and demonstrated. Many of these rely on motion estimation as a key input in order to track objects of interest across multiple pixels and “compare” pixel output values by accumulating statistics over a period of multiple frames. A key ingredient in such algorithms is a reliable motion vector which is often very difficult to generate from a video stream with a large amount of temporal and/or fixed-pattern noise. The present invention describes a method for providing a more reliable motion vector stream for such scene-based non-uniformity corrections.

4. Digital Image Stabilization

Another application of the present invention is the use of the motion vector information in order to stabilize the primary video stream in the presence of motion in the camera assembly. Besides optomechanical means for providing such stabilization, algorithms for digitally stabilizing the image have been integrated into products, including consumer products. Such methods may rely on extraction of motion information from the video stream, and measurement of such motion over a large scale indicating camera movement. This motion information may then be used to stabilize the image. This technique may in fact be combined with the types of processing described above; the camera may be actuated, or let vibrate slightly, on order to provide constant motion in the image. The high-resolution, high-SNR secondary video stream may then be used as a camera motion detector, first to stabilize the image (based on movements of the entire image), and then to provide sub-frame-scale motion information for the types of methods described above.

Motion-compensated temporal processing as described above is particularly applicable in cases where the cameras are in constant motion, such as in handheld, man-mounted, or vehicle-mounted applications. It may even be desirable (as others have demonstrated) to induce motion on the image sensor assembly in order to achieve this effect.

FIG. 2 shows an alternative embodiment of a video system 12′ in which like-numbered items may be generally similar to corresponding items of FIG. 1. The secondary video 20 is processed by a secondary motion estimation module 24′. Additionally, the video system 12′ employs a primary motion estimation module 28 and a motion merge/check module 30, whose output is a joint estimated motion vector field 32 provided to a motion-based image processor 26′. The inputs to the motion merge/check module 30 are respective estimated motion vector fields 34, 22′ from the primary and secondary motion estimation modules 28, 24′.

The primary motion estimation module 28 operates on the primary video stream 16. The purpose of the primary motion estimation module 28 is to produce a primary motion vector field 34 which is used to “check” and potentially disqualify motion estimates from the secondary motion estimation module 24′. This check can be helpful, for example, when there can be significant differences in perceived objects in the primary and secondary video streams 16, 20. For instance, if the primary video stream 16 is from a thermal infrared sensor and the secondary video stream 20 is from a visible-light sensor, then the presence of a glass window in the scene 10 may cause an exception. Visible light penetrates the window, and therefore the motion vector field 22 may include motion of visible objects behind the window. However, the window is generally opaque to thermal IR, and therefore no corresponding motion appears in the thermal IR images. In this case, it is desired that the system not use motion information from the secondary sensor 18 to process the primary video stream 16.

The motion merge/check module 30 receives the primary estimated motion vector fields 34, 22′ and generates the joint motion vector field 32 used for image processing of the primary video stream 16 by the image processor 26′. Several distinct functions may be performed in the motion check/merge module 30. Registration of the two motion fields may be performed in the case that there has been no pre-registration of the two video input streams. Such registration may be at the sub-pixel level for the primary video stream 16 which generally has a lower resolution than the secondary video stream 20. Other operations may include translation, rotation, and scaling as well as various types of distortion removal/compensation. These operations may be integrated into the operation of motion vector comparison or matching (described below), so that registration is performed at the pixel level only when the estimated motion vector fields 34, 22′ need to be compared at high resolution.

After registration, the motion merge/check block 30 compares primary and secondary motion vector values and confidence levels from the estimated motion vector fields 34, 22′ to generate a joint motion estimate. A number of rules may be applied to the generation of this joint motion estimate, based in part on the nature of the imaging modalities used by the sensors 14 and 18 as well as the system application.

The motion merge/check block 30 may perform weighting of motion field information in any of a variety of ways. In one embodiment, the weighting may be performed by use of the confidence values, such as using the following scheme:

Joint Motion Vector=[(Cp*Vp)+(Cs*Vs)]/(Cp+Cs)

where
Vp=primary motion vector
Vs=secondary motion vector
Cp=confidence level for primary motion vector
Cs=confidence level for secondary motion vector

More complex approaches may also be implemented. In one such approach, if Vp and Vs provide contradicting values, the joint motion vector might be based on Vp alone (the vector from the primary motion estimation module 28).

The motion merge/check module 30 may also employ a motion estimation approach that works at multiple scales and resolutions, starting with the very low resolution (large) objects. In such a case, weighting of spatial extent may be used. Thus, for large spatial features the vectors Vp from the primary motion estimation module 28 are more heavily weighted, whereas for smaller features (especially those below the pixel resolution of the primary sensor 14), the motion vectors Vs from the secondary motion estimation module 24′ are more heavily weighted to generate sub-pixel motion information.

Multi-resolution hierarchical motion estimation methods which are well-known may also be employed in a modified manner. These techniques generally use motion vectors extracted from low spatial resolution representations of a video stream to serve as seeds for motion estimation searches at higher resolutions—effectively providing a starting point, or limitation for the search for corresponding blocks from one frame to the next.

For example, each of the primary and secondary images may be decomposed into components at multiple resolutions. At low resolutions, representing the low-frequency spatial components of the scene, the thermal imaging channel may be used because it has sufficient spatial (pixel) resolution and, when low-pass filtered, acceptable signal-to-noise ratio. The estimated motion at these low resolutions is used to seed the motion estimation (on both image sequences) at higher resolution. At progressively higher resolutions, weighting may be shifted away from the thermal image sequence (whose signal-to-noise ratio may degrade at higher resolution) to the visible image sequence. As the resolution progresses beyond the resolution of the thermal image sensor, only the high-resolution components of the visible channel are used—as long as they are compatible with the seed value(s) passed down from the lower-resolution searches.

Application: Handheld Thermal Camera

Handheld thermal cameras are used for a number of applications. An example includes relatively low-cost, uncooled thermal imaging cameras for thermography applications. Such cameras are used to capture images representing the temperatures of objects for a variety of uses, such as structural insulation checking, electrical equipment checking, heating and air conditioning repair, moisture detection, and numerous other applications. Many such applications require very low-cost thermal inspection cameras. The major drivers of the cost of such cameras include the thermal focal plane array, and also the long-wavelength IR optics (lenses) required to form the thermal image on this array. Costs of both the array and the lenses can be significantly reduced by using lower pixel resolution, but typically such an approach results in lower thermal image quality as well. In particular such low resolution detracts from the quality of the imagery when it is presented in a printed or electronic report format on paper or a large display screen. Thus it is desirable to find ways to enhance the quality of the thermal video image from such a low-cost thermal camera.

Most of the applications of such low-cost thermographic cameras involve well-lit environments, as well as short ranges which allow the use of on-camera illumination sources. This makes possible the use of a visible camera integrated into the thermographic camera. Integration of visible cameras is in fact offered by several manufacturers of thermographic cameras, primarily for simultaneous image capture (and subsequent reporting) but also more recently for the presentation of a “fused” image (with thermal information superimposed onto a visible image) to the user for the purpose of more clearly identifying objects in the field of view.

The disclosed video enhancement technique enables a significant further enhancement to this type of camera, with the potential to improve image quality in real time and/or in reporting. Additionally, the disclosed technique could further lower the cost of such cameras by enabling the production of high-quality thermal images with a lower-resolution thermal focal plane, thereby lowering the major costs (focal plane and thermal infrared optics) in the system.

In this application, the disclosed technique is applied with the primary video sensor 14 being a thermal focal plane, and the secondary video sensor 18 being a visible-light sensor which produces a high-resolution, high-confidence motion vector field 22′ used to enhance the primary (thermal) image stream 16.

A camera of this type is typically hand-held and is therefore always in motion. The video enhancement may include pixel super-resolution to allow the generating of higher-resolution thermal images with a lower-resolution thermal focal plane. The high resolution visible light sensor 18 is used to provide an accurate, sub-pixel motion field 22′ to accomplish this super-resolution effect.

Super-resolution processing in this system may be done in real time, so as to display high resolution thermal video on the hand-held camera's screen. This requires adequate on-board image processing resources.

Alternatively, this motion-based processing may be done offline as a post-processing step. Because many thermographic cameras are used to capture still images of structures, equipment and machinery for later reporting, image quality becomes most critical in the reporting step, where it may be presented on high-resolution screens or in a printed format.

Using the disclosed technique it is possible to capture a sequence of frames from both the thermal image sensor and the visible image sensor when the user desires. This can be implemented simply by buffering multiple frames and then storing these frames in nonvolatile memory, for instance, when the user presses a “capture” button.

When the user later transfers image data to a computer for download and reporting, software on the computer may perform various functions, including motion estimation, image registration, matching/merging motion information, and subsequent image enhancement such as pixel super-resolution. This system allows the use of low-power signal processing electronics on the mobile camera (where power is at a premium and image quality is sufficient for the on-board display), and shifts the processing load to a computer which has a surplus of processing capacity, and where final image quality may be much more important.

While various embodiments of the invention have been particularly shown and described, it will be understood by those skilled in the art that various changes in form and details may be made therein without departing from the spirit and scope of the invention as defined by the appended claims.

What is claimed is:

1. A video system, comprising:
a first sensor operative in response to thermal infrared (IR) optical energy from a scene to generate a primary video sequence of thermal IR images of the scene;
a second sensor operative in response to shorter-wavelength optical energy from the scene to generate a secondary video sequence of images of the scene, the shorter-wavelength optical energy being in a shorter-wavelength range from visible to near-IR wavelengths, the first and second sensors being temporally and spatially registered with respect to each other such that a portion of the scene has a known location in each of the primary and secondary video sequences;
a sensor motion estimation module operative in response to the secondary video sequence to generate an estimated motion vector field for the scene; and
a motion-based image processor operative to generate an enhanced primary video sequence by applying one or more image-enhancement operations to the primary video sequence based on the estimated motion vector field.

2. A video system according to claim 1, wherein:
the sensor motion estimation module is a second sensor motion estimation module;
the estimated motion vector field is a second estimated motion vector field; and
the motion-based image processor applies the one or more image-enhancement operations to the primary video sequence based on a joint motion vector field generated based on the second estimated motion vector field as well as a first estimated motion vector field for the scene,
and further comprising:
a first sensor motion estimation module operative in response to the primary video sequence to generate the first estimated motion vector field; and
a merging module operative to combine the first and second estimated motion vector fields to generate the joint motion vector field, the joint motion vector field having more precise motion estimation than the first estimated motion vector field for areas of the scene for which the second estimated motion vector field provides supplementary motion estimation.

3. A video system according to claim 2, wherein each of the first and second estimated motion vector fields includes respective motion vectors as well as respective confidence values, and wherein the merging module is operative to combine the first and second estimated motion vector fields employing a weighting scheme in which the motions vectors combined in a weighted fashion according to the respective confidence values.

4. A video system according to claim 2, wherein the merging module is operative to check for inconsistency between the first and second estimated motion vector fields and to refrain from incorporating motion estimation from the second motion estimation module into the joint motion vector field when the first and second estimated motion vector fields are found to be inconsistent with each other.

5. A video system according to claim 2, wherein the second estimated motion vector field incorporates either higher resolution or higher signal-to-noise ratio than the first estimated motion vector field.

6. A video system according to claim 2, wherein the merging module is operative to perform multi-scale processing in which:
at a coarser resolution of processing the joint motion vector field is generated using vectors from the first estimated motion vector field substantially exclusively of the vectors from the second estimated motion vector field; and
at a finer resolution of processing the joint motion vector field is generated using vectors from the second estimated motion vector field substantially exclusively of the vectors from the first estimated motion vector field.

7. A video system according to claim 2, wherein the merging module performs additional image processing functions selected from the group consisting of registration, translation, rotation, and scaling.

8. A video system according to claim 1, wherein motion-based image processor is operative to perform one or more enhancement operations selected from the group consisting of temporal noise reduction, spatial noise reduction, super-resolution, non-uniformity correction, and image stabilization.

9. A video system according to claim 1, wherein the shorter-wavelength optical energy is in the visible range of wavelengths.
